(19) United States
(12) Patent Application Publication
(10) Pub. No.: US 2015/0343383 A1
(43) Pub. Date: Dec. 3, 2015

(54) REVERSE OSMOSIS EQUIPMENT PERFORMANCE CALCULATION METHOD, REVERSE OSMOSIS EQUIPMENT PERFORMANCE CALCULATION DEVICE AND PROGRAM

(71) Applicant: HITACHI, LTD., Tokyo (JP)

(72) Inventors: Youichi HORII, Tokyo (JP); Eri MATSUI, Tokyo (JP)

(73) Assignee: HITACHI, LTD., Tokyo (JP)

(21) Appl. No.: 14/655,001

(22) PCT Filed: Dec. 27, 2013
(86) PCT No.: PCT/JP2013/085140

§ 371 Date: Jun. 23, 2015

(30) Foreign Application Priority Data
Mar. 28, 2013 (JP) 2013-068753

(51) Int. Cl. B01D 61/02; G01N 13/04

(52) U.S. Cl. CPC B01D 61/025; G01N 13/04

(57) ABSTRACT

An input condition setting unit of a reverse osmosis equipment performance calculation device displays an input condition setting screen for calculating operational performance of reverse osmosis equipment on a displaying device. A calculation condition list generating unit generates a calculation condition list for a plurality of cases on the basis of the input conditions set via the input condition setting screen. An operational performance calculating unit sequentially extracts calculation conditions for one case from the calculation condition list and repeatedly performs operational performance calculations for the calculation conditions for the plurality of cases. A calculation result displaying unit displays a list of the calculation results for the plurality of cases obtained by the operational performance calculations on the displaying device.

### TECHNICAL FIELD

The present invention relates to a reverse osmosis equipment performance calculation method, a reverse osmosis equipment performance calculation device and program, which are suitable for a seawater desalination plant, etc.

### BACKGROUND ART

A method of calculating an operational performance of a water quality of product water and a pressure of a pump is known as a method of previously calculating an operational performance in development and designing phases of reverse osmosis equipments used for seawater desalination plants by inputting operational conditions such as a water quality and a temperature of seawater, a recovery rate, and flux (for example, NON-PATENT DOCUMENT 1).

### PRIOR ART

### Non-Patent Document

NON-PATENT DOCUMENT 1:
“Studies of Simulation Method Based on Concentration Polarization Theory for Reverse Osmosis Seawater Desalination Plant”, Mashahide TANIGUCHI, Masahirio, KIHARA, Hiroyuki YAMAMURA, and Masaru KURIHARA, Bulletian of the Society of Sea Water Science, Japan, Volume 56, No. 3 Jun. 1, 2002, p. 247-255.

### SUMMARY OF INVENTION

### Problem to be Solved by Invention

Incidentally, in the phase of developing and designing the reverse osmosis equipment such as a seawater desalination plant, when the operational performance is previously calculated, there are various input conditions. Accordingly, it is necessary to try to perform calculation of the operational performance of the reverse osmosis equipment for various cases in which input condition items and their values are combined to have various combinations. Further, it is necessary to perform the calculation for each model of the membranes, and when a plurality of membranes are used in combination, it is necessary to consider various layouts of the structure.

However, in the prior art method of calculating the operational performance (simulation method) of the reverse osmosis equipment disclosed in NON-PATENT DOCUMENT 1, the input condition used in the calculation is set for only one case and the operational performance of the reverse osmosis equipment and the operational performance of the reverse osmosis equipment is calculated only for the case of which input condition has been set. Accordingly, when the calculation of the operational performance of the reverse osmosis equipment is performed for each of various input conditions, it was necessary to confirm the performance by performing the calculation for each of the input condition, a model of the membrane and the different layouts of the structure.

Further, in the prior art calculation method, only one stage of the reverse osmosis membrane was considered, and in a case where a plurality of stages of membranes are used, first the operational performance of the previous stage of the reverse osmosis membrane is calculated, and secondly, the calculation result is used as input data of the membrane in the rear stage. This is repeated for obtaining an operational performance.

Accordingly, when the operational performance of the reverse osmosis equipment is previously calculated using the prior art method of calculation in the developing and designing phases of the reverse osmosis equipment, it is necessary to set an input condition of one case, calculate the operational performance under the input condition, and do work for confirming the calculation result each time for various cases. Accordingly, to select the layout and operational condition suitable for a configuration of the membranes at a developing and designing phase of the reverse osmosis equipment, a lot of man powers were needed.

The present invention may provide a reverse osmosis equipment performance calculation method, a reverse osmosis equipment performance calculation device and a program which are capable of easy selection of the layout and the operational condition which are appropriate for an object in the developing and designing phases of the reverse osmosis equipment.

### Means for Solving Problem

A reverse osmosis equipment performance calculation method according to the present invention, comprising:

a first step displaying on a display device an input condition setting screen for setting an input condition necessary for an operational performance calculation of a reverse osmosis equipment;

a second step generating calculation conditions of a plurality of cases used in the operational performance calculation as a calculation condition list on the basis of the input condition set through the input condition setting screen;

a third step successively reading out one of the cases of calculation conditions from the generated calculation condition list and executing the operational performance calculation corresponding to the read out calculation condition, which are repeated for a plurality of the cases; and a fourth step displaying a calculation result list of the plurality of the cases obtained by the operational performance calculation in the third step on the display device, the first to fourth steps are executed with a computer

In the present invention, calculations of estimating the operational performance are executed all together for a plurality of cases of which input conditions are different such as conditions of raw water, a layout, an operational condition, and a list of the calculation results is displayed on the display device. Accordingly, the user can easily compare the calculation results of the operational performance in respective cases.

### Advantageous Effect of Invention

According to the present invention, it becomes possible to easily select a layout and an operational condition for an appropriate membrane structure in accordance with the object at the developing and designing phases of the reverse osmosis membrane equipment.

### BRIEF DESCRIPTION OF DRAWINGS

FIG. 1 is a diagram illustrating an example of a block structure of a reverse osmosis equipment performance calculation device according to the embodiment of the present invention.

FIG. 2 is an illustration showing an example of an input condition setting screen displayed on a display device by an input condition setting unit.

FIG. 3 is a drawing showing an example of combination structures of membranes, wherein (a) shows an example of names of combination structures of the membranes, and (b) shows an example of layouts of the combination structures.

FIG. 4 is a drawing showing an example of a menu structure when pull-down menus are pulled-downed in an individual operational condition setting unit.

FIG. 5 is a drawing showing an example of data structure of a membrane type database.

FIG. 6 is a drawing showing an example of a raw water detail setting screen displayed on the display device by the raw water detail setting unit.

FIG. 7 is a drawing showing an example of structure of raw water condition data stored in the raw water condition storing unit.

FIG. 8 is a drawing showing an example of an structure of the operational condition data stored in the operational condition storing unit.

FIG. 9 is a drawing showing an example of a structure of product water condition data stored in the product water condition storing unit.

FIG. 10 is a drawing showing an example of a structure of calculating condition list data stored in the calculating condition list storing unit.

FIG. 11 is a drawing showing an example of an structure of operational performance calculation result data stored in the operational performance calculation result storing unit.

FIG. 12 is a drawing showing an example of a structure of a calculation result list display screen displayed by a calculation result list display unit.

FIG. 13 is a drawing showing an example of a calculation result detail display screen displayed by the calculation result detail display screen.

### MODES FOR CARRYING OUT INVENTION

Embodiments of the present invention are described in details with reference to the drawings below.

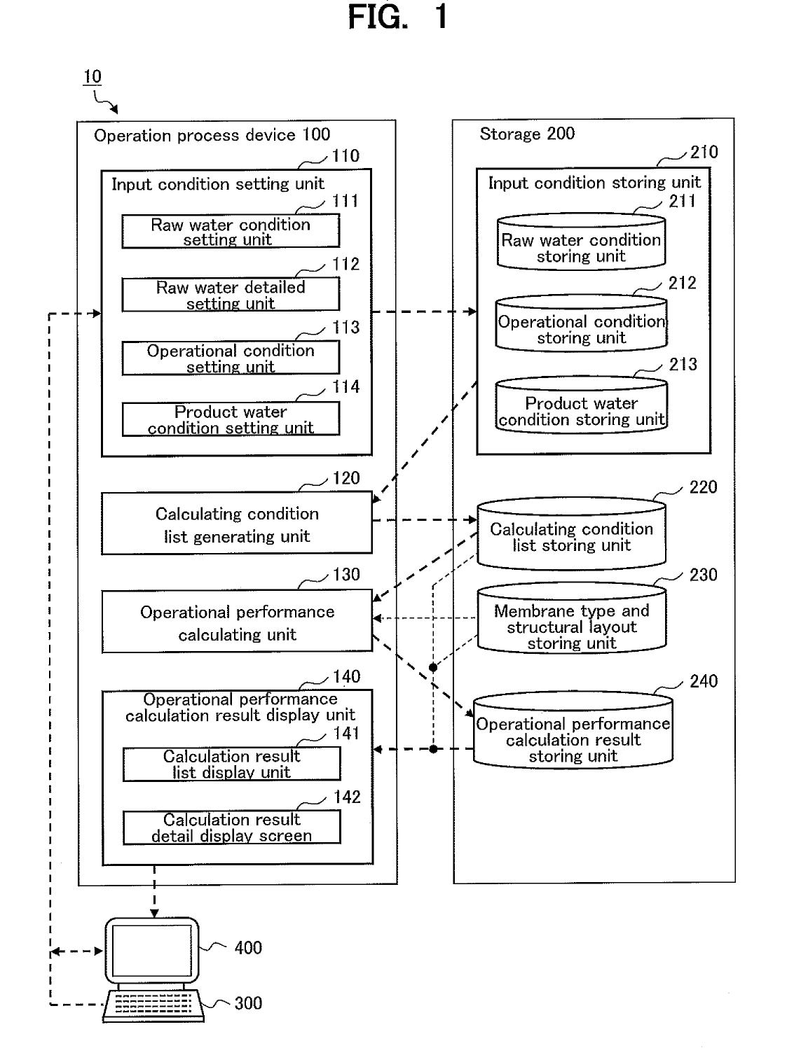

FIG. 1 is a block diagram of a reverse osmosis equipment performance calculation device 10 according to embodiments of the present invention. As shown in FIG. 1, hardware of the reverse osmosis equipment performance calculation device 10 is configured including an operation process device 100, a storage 200, an input device 300, a display device 400, etc., and more specifically, it is provided using a so-called computer.

The operation process device 100 corresponds to a CPU (Central Processing Unit) as called in a computer. The storage 200 is configured including a main memory such as a ROM (Read Only Memory), a RAM (Random Access Memory), etc. and an auxiliary storage such as a hard disk drive and SSD (Solid State Disk). The input device 300 is configured including a keyboard, a mouse, a touch panel, etc. The display device 400 is configured including an LCD (LCD: Liquid Crystal Display), etc.

Further, as shown in FIG. 1, the operation process device 100 includes blocks whose functions are provided by program processes, such as an input condition setting unit 110, a calculating condition list generating unit 120, an operational performance calculating unit 130, and an operational performance calculating result display unit 140.

More specifically, the functions of the input condition setting unit 110, the calculating condition list generating unit 120, the operational performance calculating unit 130, the operational performance calculating result display unit 140, etc. are provided by executing programs previously stored in the storage 200 by the operation process device 100.

Further, the storage 200 includes blocks for storing various types of data such as an input condition storing unit 210, a calculating condition list storing unit 220, a membrane type and structural layout storing unit 230, an operational performance calculation result storing unit 240, etc.

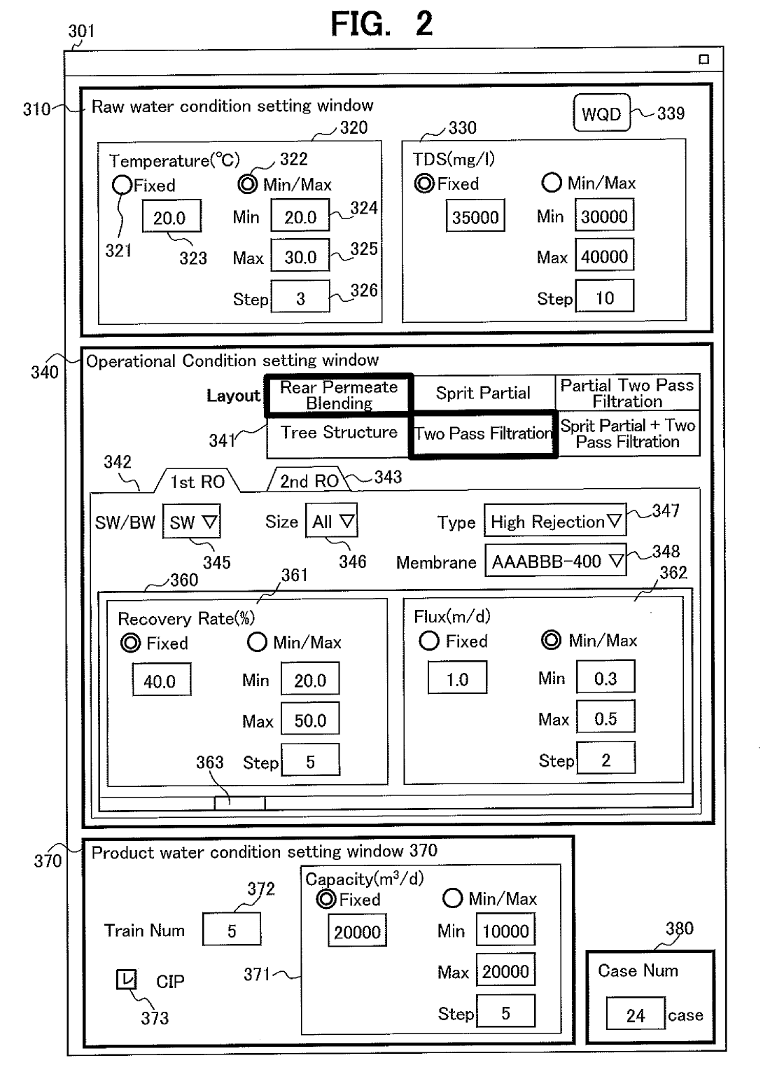

Referring to FIG. 1, general functions of these blocks are described and after that, details of each block are described with reference to FIGS. 2 to 12.

The input condition setting unit 110 has a function of setting data of various type of input conditions necessary for calculating an operational performance of a reverse osmosis equipment as an estimation target and configured including sub-blocks such as a raw water condition setting unit 111, a raw water detail setting unit 112, an operational condition setting unit 113, a product water condition setting unit 114, etc.

The input condition storing unit 210 has a function storing data of various types of the input condition data set by the input condition setting unit 110 and is configured including sub-blocks such as a raw water condition storing unit 211, an operational condition storing unit 212, a product water condition storing unit 213, etc. Further, in the raw water condition storing unit 211, the operational condition storing unit 212, the product water condition storing unit 213, data set in the raw water condition setting unit 111, the raw water detail setting unit 112, the product water condition storing unit 213, and the product water condition setting unit 114 are stored, respectively.

The calculating condition list generating unit 120 generates a plurality of calculating lists on the basis of the data of various types of input conditions stored in the input condition storing unit 210 which lists are stored in a calculating condition list storing unit 220. Here, the calculating condition list is a group of data necessary for performing the process of the operational performance calculating unit 130 once (for one case).

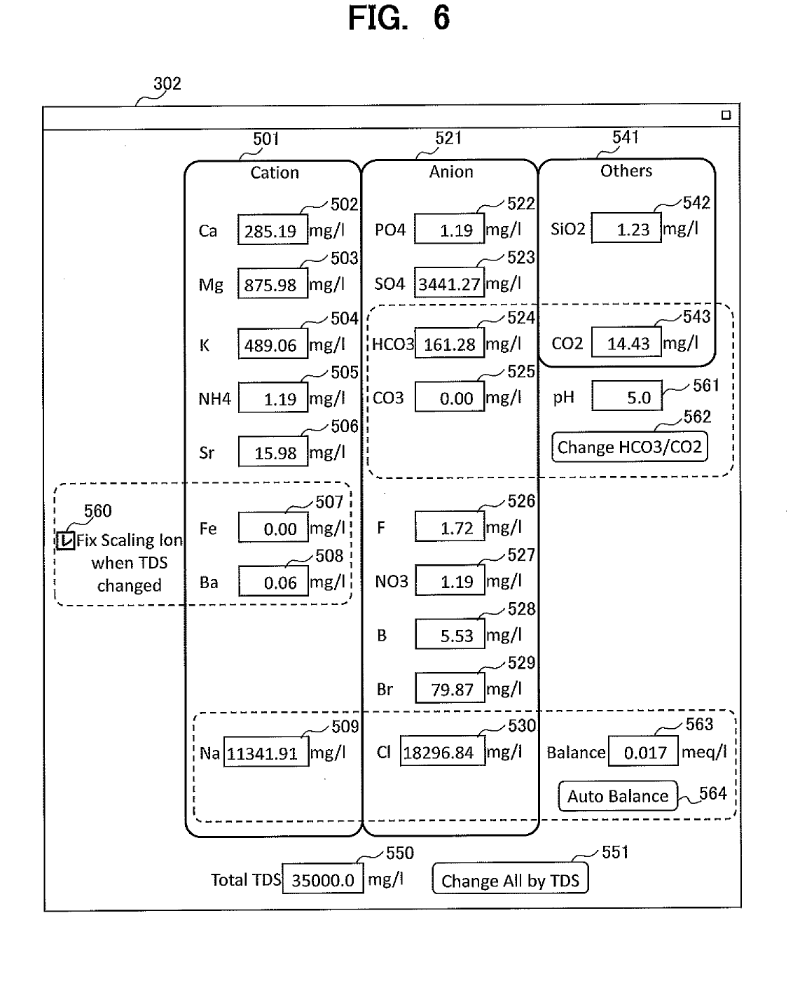

Further, it is assumed that in the membrane type and structural layout storing unit 230, data of characteristics of the membranes used in the reverse osmosis equipment to be estimated and layout of the membranes in combination, etc. is previously stored, including the membrane type database (see FIG. 5) described later. It is noted that in the present description, the reverse osmosis membrane used in the reverse osmosis membrane equipment to be estimated is simply called “membrane” hereinafter.

The operational performance calculating unit 130 reads, one case by one case, the calculation condition list of a plurality of cases stored in the calculating condition list storing unit 220 and repeatedly executes a process of calculating operational performances to be estimated in accordance with the input conditions defined by respective calculation condition lists the-number-of-calculation-condition-lists(the-number-of-cases)-times stored in the calculating condition list storing unit 220. The result is stored in the operational performance calculation result storing unit 240. Further, in the process of calculating an operational performance, data stored in the membrane type and structural layout storing unit 230 is appropriately referred. Further, for the calculation process of the operational performance calculating unit 130, a calculation process based on a simulation method disclosed in, for example, NON-PATENT DOCUMENT 1 can be used.

The operational performance calculating result display unit 140 displays data stored in the calculating condition list storing unit 220, the membrane type and structural layout storing unit 230, and the operational performance calculation result storing unit 240, i.e., the calculation results (estimation result) of the operational performance of the reverse osmosis equipment calculated by the operational performance calculating unit 130.

Further, the operational performance calculating result display unit 140 is configured including sub-blocks such as the calculation result list display unit 141, the calculation result detail display unit 142, etc. The calculation result list display unit 141 displays a list of the calculation results of the operational performance of the reverse osmosis equipment corresponding to respective calculation condition lists. Further, the calculation result detail display unit 142 displays a detailed calculation result of the operational performance of the reverse osmosis membrane corresponding to the calculation condition list of one case selected from the list displayed by the calculation result list display unit 141.

FIG. 2 is an illustration showing an example of an input condition setting screen displayed on the display device 400 by the input condition setting unit 110. As shown in FIG. 2, on an input condition setting screen 301, sub-screens are displayed such as a raw water condition setting window 310, an operational condition setting window 340, a product water condition setting window 370, the-number-of-case display window 380, etc.

The raw water condition setting window 310 gives the user a function of setting the raw water condition displayed by the raw water condition setting unit 111. There are raw water conditions such as a temperature of raw water, a TDS (Total Dissolved Solids) of the raw water, etc. as the raw conditions. On the raw water condition setting window 310, a temperature setting unit 320, a TDS setting unit 330, etc. and a WQD (Water Quality Detail) button 339 for calling a process of the raw water detail setting unit 112 are displayed.

In the temperature setting unit 320, for example, radio buttons 321 and 322 and value entry fields 323, 324, 325, and 326 are displayed. Here, when the radio button 321 is selected, a temperature of the raw water is fixed to the temperature inputted into the value entry field 323. Further, when the radio button 322 is selected, the temperature of the raw water is varied to a temperature between the lowest temperature inputted in a value entry field 324 and the maximum temperature inputted into a value entry field 325

Also at the TDS setting unit 330, radio buttons and value entry fields having similar shapes are displayed and similarly the condition data is set for TDS. When the WQD button 339 is pressed, the process of the raw water detail setting unit 112 is executed, and a raw water detail setting screen for setting a water quality in detail such as components of TDS of the raw water is newly displayed. Further, the raw water detailed setting screen will be described separately with reference to FIG. 6 later.

In FIG. 2, the operational condition setting window 340 is displayed by the operational condition setting unit 113, and gives the user a function of setting operational conditions of the reverse osmosis equipment to be estimated. At the operational condition setting window 340, a layout selection entry field 341 for selection for the “membrane combination structure” and an individual operational condition setting unit 342, 343 for the membrane used in the structure selected by the layout selection entry field 341 for selection of “combination structure of membranes”, etc. are displayed.

At this instance, a name of “combination structure of membranes” previously prepared is displayed, and the user can easily set the combination structure of the membranes for the reverse osmosis equipment to be estimated by approximately selecting the name.

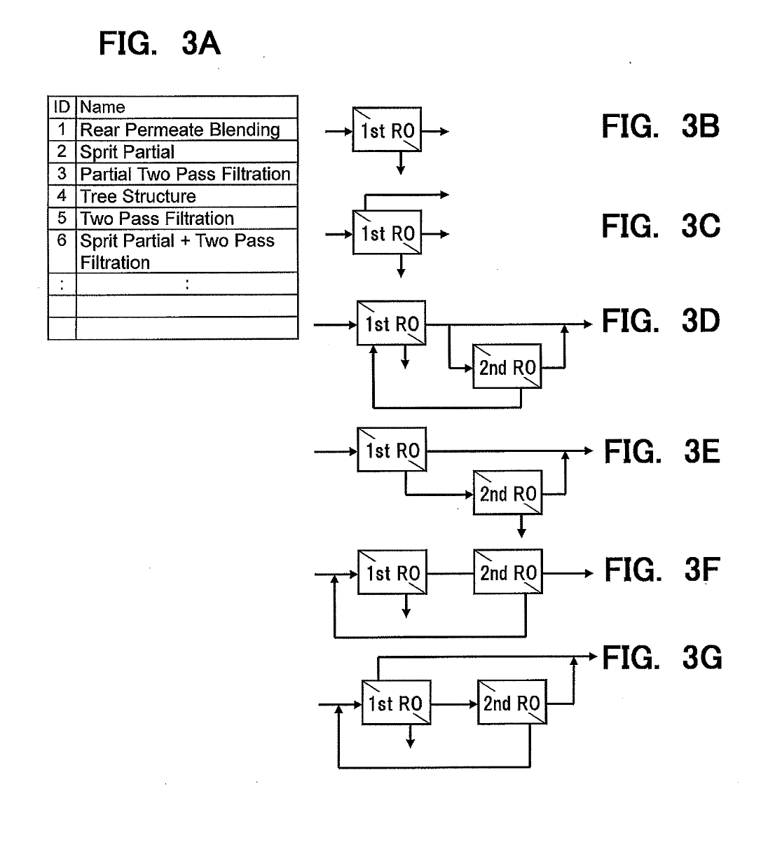

FIG. 3 is drawings showing an example of combination structures of membranes, wherein FIG. 3(a) shows an example of names of combination structures of the membranes, and FIG. 3(b) shows an example of layouts of the combination structures. In FIG. 3(b), “1st RO” means a first stage of the membrane, and “2nd RO” means a second stage of the membrane. Further, arrows entering the boxes indicated with “1st RO” and “2nd RO” mean processed water supplied to the membranes, and the arrows extending from the box in the right direction or the upper direction means production of permeable waters by the membrane, and an arrow outwardly extending from the box means production of concentrated water by the membrane.

Accordingly, out of the layouts of the combination structures of membranes shown in FIG. 3, “Rear Permeate Blending” and “Sprit Partial” is a structure using only one membrane and the others are structures using two membranes.

Data of the names and layouts data of combination structures of the membranes are previously registered in the membrane type and structural layout storing unit 230. Further, the types of the combination structures of the membranes are not limited to six types shown in the drawing. but may be other structures.

Referring to FIG. 2 again, the user can individually set the operational condition for one or a plurality of the membranes used in the membrane combination structure selected at the layout selection entry field 341 through the individual operational condition setting units 342, 343. More specifically, in the case where a plurality of membranes are used, the individual operational condition setting units 342, 343 switchable by tabs for each of the membranes are displayed.

At this instance, at the individual operational condition setting unit 342, pull-down selection menus 345, 346, 347, 348 are displayed for selecting type and model of the used membrane and as well as an operational condition data setting frame 360 is displayed.

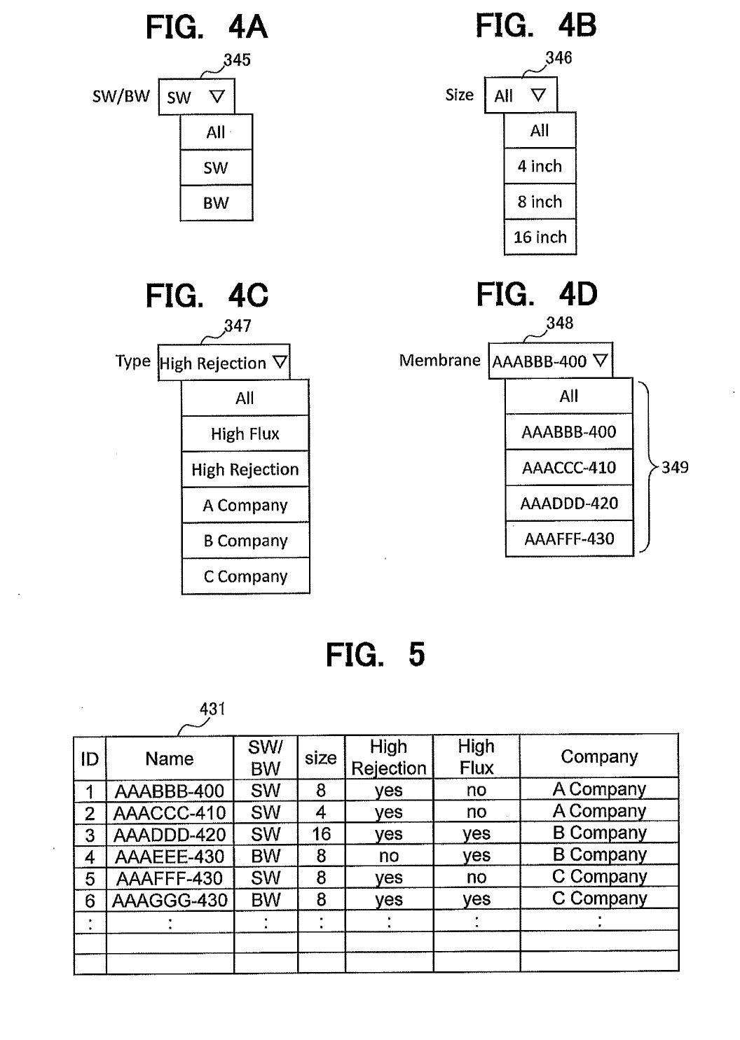

FIG. 4. is a drawing showing examples of menu structures when the pull-down selection menus 345, 346, 347, and 348 are pulled down, respectively.

In FIG. 4, the pull-down selection menu 345 designated with a name of “SW/BW” is a menu for selecting one of intended proposes of the membrane, and the user can select one from all (All), a sea water reverse osmosis membrane (SW), and a brackish water reverse osmosis membrane (BW).

Further, a pull-down selection menu 346 designated with “Size” is a menu for selecting one of sizes of the membrane in diameter, and the user can select one from all (All), 4 inch, 8 inch, 16 inch, etc.

Further, a pull-down selection menu 347 designated with a name of “Type” is a menu for selecting one of types or kinds of the membrane, and the user can select one from all (All), a high flux type (High Flux), a high rejection type (High Rejection), a membrane manufacture by A company (A Company), a membrane manufactured by B company (B Company), a membrane manufactured by C company (C company), etc.

Further, a pull-down selection menu 348 designated with a name of “Membrane” is a menu for selecting one of specific model names of the membrane. More specifically, when the user selects the pull-down selection menu 348, the operational condition setting unit 113 searches a membrane type database 431 (see FIG. 5) for the type name of the membrane meeting the conditions of the use purpose or type, etc. of the membrane selected by the pull-down selection menus 345, 346, 347 and the pull-down selection menu, and display the model name of the extracted membranes as item names of the pull-down selection menu 348.

FIG. 5 is a drawing showing an example of data structure of a membrane type database 431. As shown in FIG. 5, row data of the membrane type database 431 is configured including “ID”, “Name”, “SW/BW”, “size”, “High Rejection”, “High Flux”, “Company”, etc. Here, “ID” represents an identification number, “Name” represents a model name of the membrane, “SW/BW” represents a use of the membrane (for seawater/brackish water), “size” represents a size of the membrane in diameter, “High Rejection” represents whether the membrane is of a high rejection type or not, “High Flux” represents whether the membrane is of a high flux type or not, and “Company” represents a manufacturing company of the membrane.

Further, the examples of the pull-down selection menus 345, 346, 347 in FIGS. 2 and 4, are drawn such that “SW”, “All”, and “High Rejection” were selected, respectively. In this state, when the user selects the pull-down selection menu 348, the membrane type database 431 (see FIG. 5) is searched, and membranes having model names of AAABBB-400”, “AAACCC-410”, “AAADDD-420”, “AAAFFF-430” having data corresponding to all of “SW”, “All”, and “High Rejection” are extracted from the membrane type database 431. The model names of the extracted membranes are displayed in a pull-down selection menu 349 (see FIG. 4) which is pulled down from the pull-down selection menu 348.

Then, the user can easily determine the membranes to be estimated and used in the reverse osmosis equipment by selecting one or more model names of the membranes from the pull-down selection menu 349.

Referring to FIG. 2 again, the operational condition data setting frame 360 is described. As shown in FIG. 2, a recovery rate (Recovery Rate) setting unit 361, a flux (Flux) setting unit 362, etc. are displayed in the operational condition data setting frame 360. In the recovery rate setting unit 361 and the flux setting unit 362, like the case of the temperature setting unit 320 of the raw water condition setting window 310, radio buttons for selecting a recovery rate and selecting whether the flux is set to a fixed value or variable value. Further, value entry fields, etc. are displayed for inputting a fixed value, and a maximum value, a minimum value, and the number of variation steps, of the variation value.

In FIG. 2, though only the recovery rate setting unit 361 and the flux setting unit 362 are drawn in the operational condition data setting frame 360, other operational condition data may be displayed such as a membrane age, the number of membrane elements per a pressure vessel (Vessel). Further, also the operational condition data can be set with fixed values or variable values like the case of the flux setting unit 362 and the flux setting unit 362. Further, in a case where they cannot be displayed within the operational condition data setting frame 360, it is enough to display non-displayed part by shifting the displayed part with a scroll bar 363.

In FIG. 2, the product water condition setting window 370 is displayed by the product water condition setting unit 114 to give the user a condition setting function of product water. Accordingly, on a product water condition setting window 370, a product water amount setting unit 371, a value entry field 372, and a product water, the CIP check box 373, etc. are displayed. The product water amount setting unit 371 is for setting an amount of the product water produced by the reverse osmosis equipment specified at the operational condition setting window 340. The value entry field 372 is for inputting the number of trains (Train Num) installed in the water treatment plant including the corresponding reverse osmosis equipment. The CIP check box 373 is for specifying that the amount of the product water of the whole of the plant is produced by other trains.

In the product water amount setting unit 371, like the case of the temperature setting unit 320 of the raw water condition setting window 310, a radio button is displayed for selecting whether the amount of the product water is set to a fixed value or a variable value, and value entry fields, etc. are displayed for inputting a fixed value of the amount of product water, a maximum value, a minimum value, and the number of variable steps, of the variable value.

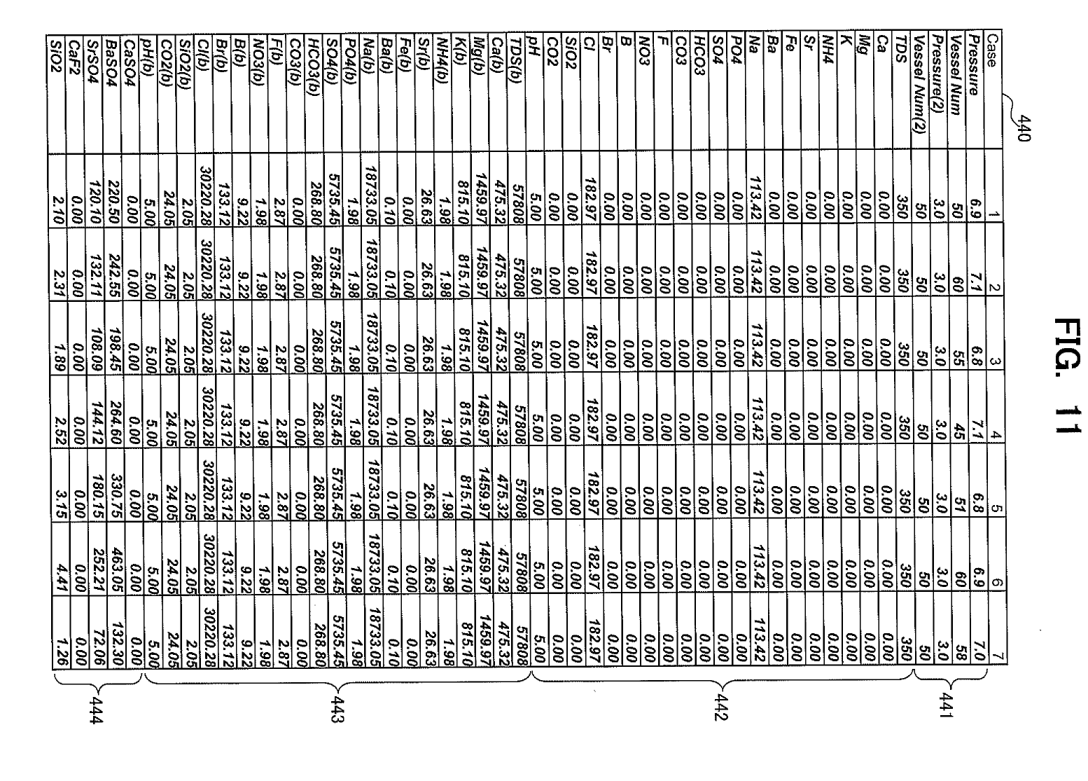

The CIP check box 373 is checked when one train is stopped for maintenance in the case where the amount to the product water of the whole of the plant is produced by other trains. More specifically, when the CIP check box 373 is checked, a calculation condition is added to its calculation list upon generation of the calculation condition list described later (see FIG. 10).

Further, in FIG. 2, displayed on the the-number-of-case display window 380 is the number of combinations (cases) of the calculation condition data inputted in the operational performance calculating unit 130 which is obtained on the basis of the various conditions set on the raw water condition setting window 310, the operational condition setting window 340, and the raw water condition setting window 370.

Regarding this, in the example shown in FIG. 2, variable values are set at the temperature setting unit 320 and the flux setting unit 362, and the number of steps (the number of sections) are set to 3 and 2, respectively. Further, the CIP check box 373 is checked, and at the layout selection entry field 341, a configuration of combining two types of membranes is selected. Accordingly, the number of combinations of the calculation condition data entered in the operational performance calculating unit 130 are total 24 cases i.e., three cases (of temperature)×two cases (of flux)×two cases (of train check)×two cases (of layouts).

FIG. 6 is a drawing showing an example of a raw water detail setting screen 302 displayed on the display device 400 by the raw water detail setting unit 112. The raw water detail setting unit 112 sets substances and their concentrations (amount (weight) of the dissolved substance in one little of the raw water) included in the raw water supplied to the reverse osmosis equipment to be estimated on the basis of the data inputted through the raw water detail setting screen 302.

As shown in FIG. 6, displayed at the raw water detail setting screen 302 are a cation (Cation) setting unit 501, an anion (Anion) setting unit 521, and the others (Others) setting unit 541, etc. Displayed at the cation setting unit 501 are value entry fields 502 to 509 for inputting cation ion concentrations of, for example, calcium (Ca), magnesium (Mg), potassium (K), ammonia (NH4), strontium (Sr), iron (Fe), barium (Ba), sodium (Na), etc, respectively.

Further, displayed on the anion (Anion) setting unit 521 are value entry fields 522 to 530 for inputting anion ion concentrations of, for example, phosphoric acid (PO4), sulfuric acid (SO4), bicarbonate (HCO3), carbonic acid (CO3), fluorine (F), nitric acid (NO3), boron (B), bromine (Br), chlorine (CO, etc, respectively. Further, on the others setting unit 541 are value entry fields 542 and 543 for inputting, for example, concentrations of silicon dioxide (SiO2), carbon dioxide (CO2), etc. respectively.

The user can set the concentrations of the cation, anion, and other substances contained in the raw water through the value entry fields 502 to 509, 522 to 530, 542, and 543. Further, totals of the concentration of the cations, anions, other substances are displayed at a Total TDS field 550.

As described above, after once the total of concentrations of the cation, the anion, and the other substances are displayed in the Total TDS field 550, when the value in the Total TDS field 550 is changed by User's input, and a Change All by TDS button 551 is pressed, the raw water detail setting unit 112 changes the concentrations of all the cations, anions, and other substances to have values after change in the Total TDS field 550, while a ratio of concentrations of the cations, anions, and other substances which have been set is maintained.

However, when a check box 560 for “Fix Scaling Ion when TDS changed” has been checked, ion concentrations of the iron (Fe) and barium (Ba) are not changed

Further, when a pH value is entered in a pH entry field 561 and a button 562 for Change HCO3/CO2” is depressed, the raw water detail setting unit 112 calculates ion concentrations of carbon dioxide (CO2) and carbonic acid (CO3) from the concentration of bicarbonate ion and the inputted pH values and changes the values, respectively. In calculation, the method described in the known document (such as the Meteorological Agency, Meteorological Research Institute technical report No. 41, p. 5-7, May 2000) can be used.

Further, in a ion balance (Balance) field 563, an ion balance calculated from the input concentrations of cation and anion and molecular weight is displayed. At the instance, when a “Auto Balance” button 654 is depressed, the raw water detail setting unit 112 increases natlium (Na) ion concentration and chlorine (Cl) ion concentration to have ion balance. On the basis of the result, values displayed in a value entry fields 509, 530 for sodium (Na) ion concentration and chlorine (Cl) ion concentration and the value displayed in the ion balance (Balance) field 563 are changed.

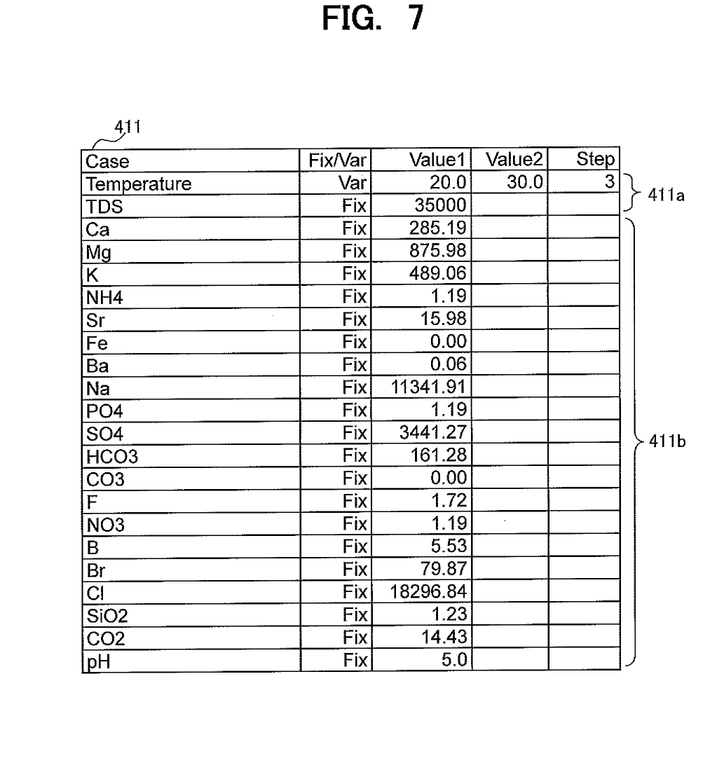

FIG. 7 is a drawing showing an example of structure of raw water condition data stored in the raw water condition storing unit. As shown in FIG. 7, data at each row of a raw water condition data 411 is configured including item data of “Case”, “Fix/Var”, “Value1”, “Value2”, “Step”, etc. A data 411a at first and second rows of the raw water condition data 411 is generated by the raw water condition setting unit 111, and the data 411b at the third row and thereafter is generated by the raw water detail setting unit 112.

More specifically, as the raw water condition data 411a on the first and second rows of the raw water condition data 411, data of a temperature of the raw water set by the temperature setting unit 320 and data of TDS set by the TDS setting unit 330, respectively are stored. In that case, in fields of item of “Case”, “Temperature” or TDS” is stored, and in the field of “Fix/Var”, data for specifying between Fix data/Variable data are stored. Further, in each of the fields of “Value1”, “Value2”, and “Step”, a fixed value is stored in a case of a fixed data, and in the case of the variable data, minimum, and maximum data and the number of sections of the data (the number of steps) are stored.

As data 411b below the third row of the raw water condition data 411, data of a cation, an anion, and other substances set by the raw water detail setting unit 112 are stored, respectively.

In that case, in the fields of the item of “Case”, names of cation, anion, other substances which are components of TDS are stored and in fields of “Value1”, their concentrations are stored. Further, in the fields of item “Fix/Var”, data indicating that the data indicating fixed data is stored. Further, at an end of the data 411b, a pH value is also stored.

In addition, in the embodiment, concentrations of the cation, the anion, and other substances are fixed data, but may be variable data which individually varies.

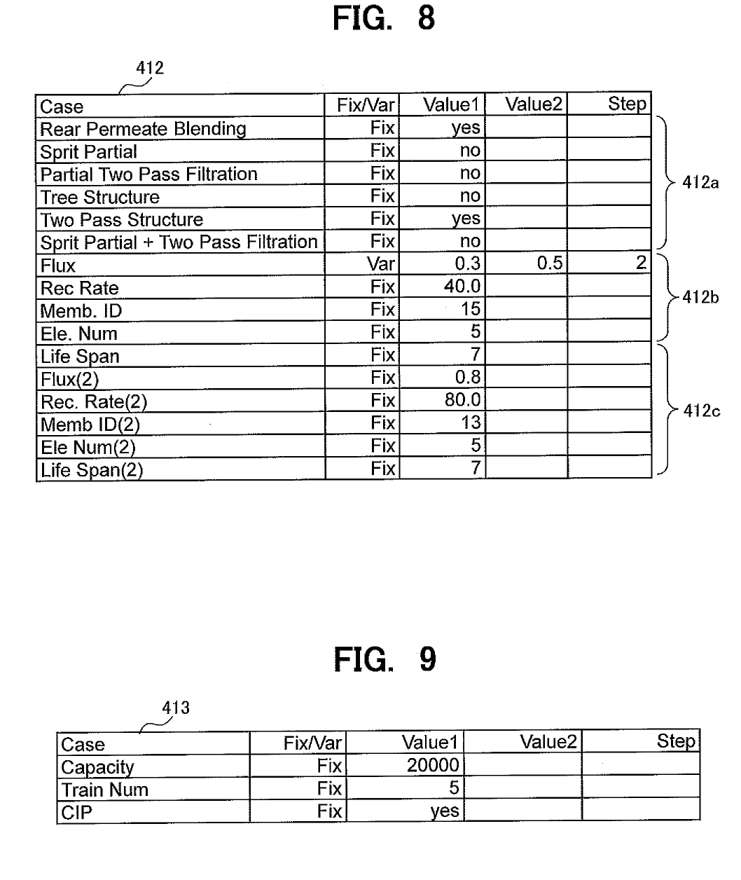

FIG. 8 is a drawing showing an example of an structure of the operational condition data 412 stored in the operational condition storing unit 212. As shown in FIG. 8, data on each row of operational condition data 412 is configured including item of “Case”, “Fix/Var”, “Value1”, “Value2”, and “Step”, etc. In the example in FIG. 8, in the field of the item “Case”, an operational condition name is stored, in the field of “Fix/Var”, data for distinguish between fixed data/variable data is stored, and in each fields of the item “Value1”, “Value2”, and “Step” a fixed value is stored in the case of the fixed data and a minimum and maximum values and data of the number of steps (step number) are stored in the case of the variable data.

Data 412a on the first six rows of the operational condition data 412 corresponds to layout data of a combination structure of the membranes selected by the layout selection entry field 341 on the input condition setting screen 301 (see FIG. 2). In this case, in a field of the item “Case”, a layout name of the combination structure of the membranes is stored. In the field of the item “Value1”, data of “Yes” or “No” is stored, which indicates a selection status of the layout of the combination structure of the membrane.

Regarding this, in FIG. 2, “Rear Permeate Blending”, and “Two Pass Filtration” are selected by the layout selection entry field 341. Accordingly, in the operational condition data 412 in FIG. 8, in the fields of the item “Value1” on the rows of which the item “Case” field is “Rear Permeate Blending” or “Two Pass Filtration”, “Yes” is stored to indicate that they are selected.

Next, in a data 412b on the five rows following the operational condition data 412, the flux (Flux), the recovery rate (Rec Rate), identification number of the membrane, (Memb ID), which are set by the individual operational condition setting unit 342 on the input condition setting screen 301 (see FIG. 2), and the number of membrane elements per vessel (Ele. Num), and the membrane age (Life Span), which are set by the membrane type and structural layout storing unit 230 are stored. In data 412c on the five rows further following the operational condition data 412, the individual operational data of the membrane at a second stage set by an operational condition data setting unit 343 and the membrane type and structural layout storing unit 230 is similarly stored.

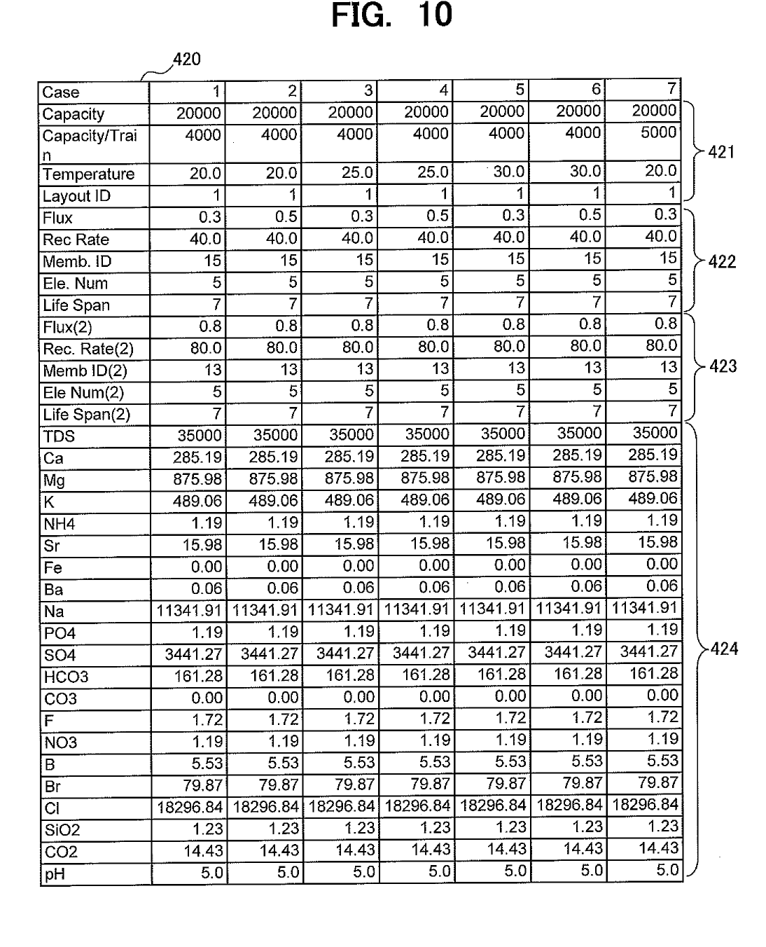

FIG. 9 is a drawing showing an example of a structure of the product water condition data 413 stored in the product water condition storing unit 213. As shown in FIG. 9, data of each row of product water condition data 413 is configured including item data of “Case”, “Fix/Var”, “Value1”, “Value2”, and “Step”. In the case shown in FIG. 9, in the field of the item “Case”, a product water amount (Capacity), the number of trains (Train Num), and presence and absence of a check in the CIP check box 373 (CIP), which are condition names of the product water. Further, in the field of the item “Fix/Var”, data distinguishing between fixed data/variable data is stored. In the fields of the items “Value1”, “Value2”, and “Step”, a fixed value in the fixed data in the case of the fixed data, or minimum and maximum values and the number of data steps (step number) in the case of variable data are stored.

FIG. 10 is a drawing showing an example of a structure of calculating condition list data 420 stored in the calculating condition list storing unit 220. At this instance, data on the first row in the calculating condition list data 420 is a name of data necessary for calculation in the operational performance calculating unit 130 (see FIG. 1). Further, data in each line on and after the second line are values set by the raw water condition setting window 310, the operational condition setting window 340, or the product water condition setting window 370 with respect to each data specified by the name of the data on the first line.

Data on and after the second lines is data used for once calculation (one case) by the operational performance calculating unit 130, and the number on each field on the first row on and after the second line indicates a case number of once calculation in the operational performance calculating unit 130. Accordingly, data in each line are different on at least one row.

Further, in the example in FIG. 2, the case number is displayed as “24” in the the-number-of-case display window 380. On the other hand, in the example shown in FIG. 10, only the fields of “Case” on seven lines are shown. In this case, there are data in the lines corresponding to fields of “Case” indicating “8” to “24”, but indication of the data are omitted.

Further, in FIG. 10, out of data 421 on the first four rows of the calculating condition list data 420, the amount to the product water of the whole of the plant (Capacity) and the product water amount per train (Capacity/Train) is obtained from the product water condition data 413 (see FIG. 9), the temperature (Temperature) is obtained from the raw water condition data 411, and the number of the membrane combination (Layout ID) is obtained from the operational condition data 412.

Further, data 422 on five rows (fifth to ninth rows) of the calculating condition list data 420 are obtained from the flux (Flux), the recovery rate (Rec Rate), the identification number of the membrane (Memb ID), the number of membrane elements per vessel (Ele. Num), and membrane age (Life Span) obtained from the operational condition data 412 of the membrane at the first stage, obtained from the data 412b. Similarly, data 423 on further following five rows is obtained from the individual operational condition data 412c of the membrane at the second stage in the operational condition data 412.

Data 424 after the fifteenth row of the calculating condition list data 420 is data indicating water quality of the raw water obtained from the raw water condition data 411 (see FIG. 7).

FIG. 11 is a drawing showing an example of a structure of operational performance calculation result data 440 stored in the operational performance calculation result storing unit 240. At this instance, data on the first line of the operational performance calculation result data 440 indicates names of data obtained by the operational performance calculating unit 130 (see FIG. 1). Further, data on each of lines on and after the second line is data obtained by the process of the operational performance calculating unit 130 (see FIG. 1) when data on and after the second line of the calculating condition list data 420 (see FIG. 10) are used as the calculation condition data of one case.

Further, in FIG. 11, a data 441 on first four rows of the operational performance calculation result data 440 indicates pressures (Pressure) and the number of vessels (Vessel Num) of the first and second membranes, respectively. Further, data 442 on fifth to twenty-fifth rows are data indicating a quality of the product water, and data 443 on the twenty-sixth to the forty-sixth rows is data indicating a water quality of the concentrated water. Further, data 444 on five rows after the forty-seventh row are data indicating saturated concentration ratio (%) of scaling components such as calcium sulfate (CaSO4), barium sulphate (BaSO4), strontium sulphate (SrSO4), calcium fluoride (CaF2), and silicon dioxide (SiO2).

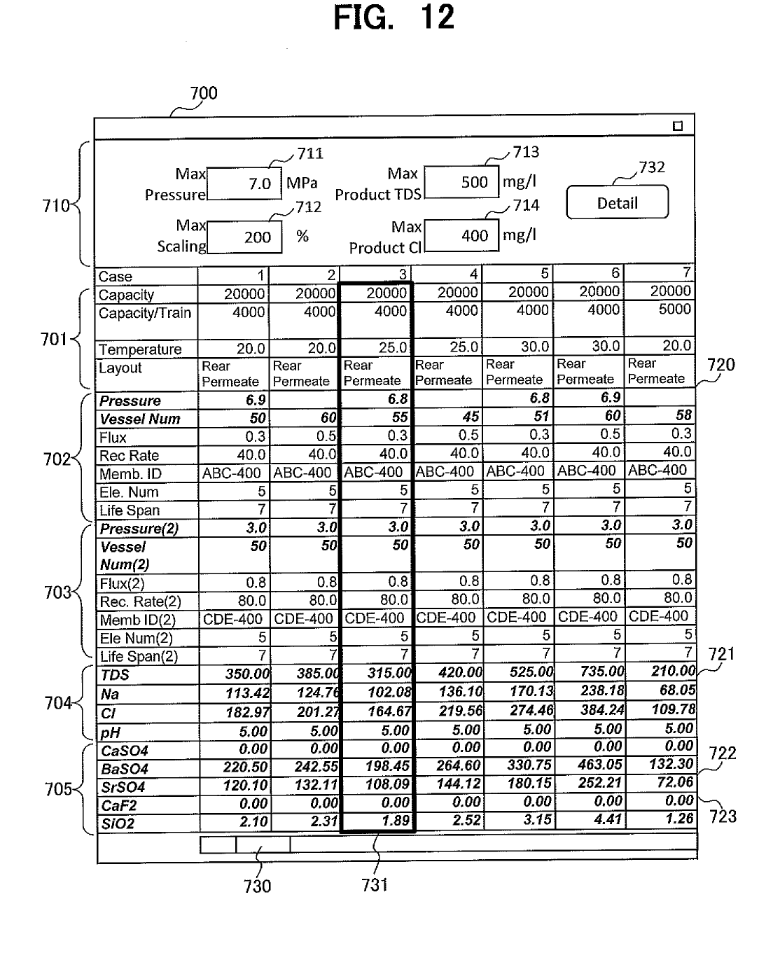

FIG. 12 is a drawing showing an example of an structure of a calculation result list display screen 700 displayed by the calculation result list display unit 141. On the calculation result list display screen 700, main data is displayed line by line for each case out of the operational performance calculation result data 440 for all cases stored in the operational performance calculation result storing unit 240. Further on the calculation result list display screen 700, in addition to data of the calculation result, data set in the input condition setting unit 110 and a narrowing condition setting window 710 for narrowing the calculation result are also shown in consideration of user's convenience. Further, in FIG. 12, the data of the calculation result are displayed with bold-italic fonts.

As shown in FIG. 12, as display data 701, a product water amount of the whole of the plant (Capacity), a product water amount per train (Capacity/Train), a temperature (Temperature), a layout of membrane combination (Layout) are displayed. Further, as display data 702, 703, the operational data of the membrane such as pressures (Pressure) at first and second stages of membranes, the number of vessels (Vessel Num), the flux (Flux), the recovery rate (Rec Rate), the membrane identification number (Memb. ID), the number of elements per vessel (Ele. Num), the membrane life time (Life Span) of the first and second membranes, etc. Further, as a display data 704, the TDS of the product water (TDS), the concentration of sodium ions (Na), chlorine ion concentration (CO, the pH value, and as display data 705, the saturated concentration ratio of scaling component of concentrated water (%) are displayed.

In FIG. 12, data of cases after the eighth case is not shown. However all data can be displayed by appropriately shifting a scroll bar 730 from side to side. In FIG. 12, the data of calculation results is displayed in an order of the case number. However, the data can be displayed with sorting in an order of values of one of performances selected by the user (for example, pressure).

Further, as shown in FIG. 12, there are narrowing condition entry fields 711, 712, 713, 714 for narrowing the calculation results desired by the user from the calculation results of the respective cases displayed on the calculation result list display screen 700 on the narrowing condition setting window 710. With the narrowing condition entry fields 711, 712, 713, 714, it is possible to set the maximum pressure (Max Pressure), a maximum saturated concentration ratio of scaling component of concentrated water (%)(Max Scaling), the maximum TDS of the product water (Max Product TDS), and the maximum chlorine ion concentration of the product water (Max Product Cl), respectively.

Then, when the narrowing condition data is inputted through the narrowing condition entry fields 711, 712, 713, 714, the calculation result list display unit 141 displays in a highlighted display the data of the case meeting all the condition data from the data of each case displayed on the calculation result list display screen 700. The highlighted display is a display easy to be distinguishable from the data of other cases which is provided by displaying with a high brightness or with a fresh color different from other data.

In the example in FIG. 12, on the rows designated with references 720, 721, 722, 723, there is data not meeting the condition data set in the narrowing condition entry fields 711, 712, 713, 714, and the data not meeting the narrowing condition data is white/black-reverse-displayed. Accordingly, in the example shown in FIG. 12, data 731 of the case 3 meets the condition data previously set and each data of other cases does not meet at least one of the condition data piece

Further, in the example shown in FIG. 12, the data which does not meet at least one piece of the narrowing condition data is distinguishably displayed with low brightness by half tone dot meshing, etc. However, such data can be not displayed (hidden).

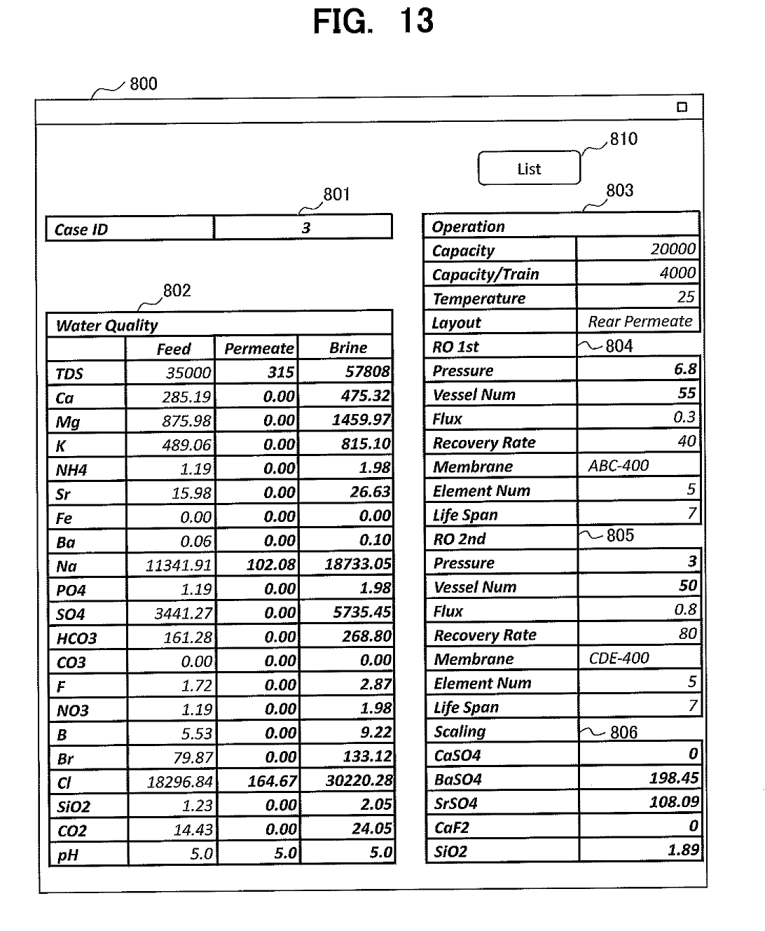

Further, on the calculation result list display screen 700 in FIG. 12, there is shown a “Detail” button 732. When the user access the detail calculation result, for example, the user selects the case number to be accessed and the “Detail” button 732 is pressed, a calculation result detail display screen 800 shown in FIG. 13 is displayed.

FIG. 13 is a drawing showing an example of a calculation result detail display screen 800 displayed by the calculation result detail display unit 142. On the calculation result detail display screen 800, there are displayed a case number display field 801, a water quality data list 802, an operational data list 803, and a “List” button 810.

Here, the case number selected on the calculation result list display screen 700 is displayed on the case number display field 801. On each of fields of the water quality data list 802, data of the water quality is displayed regarding a raw water (Feed), Product water (Permeate), and condensed water (Brine). Further, on the operational data list 803, the product water amount of the whole of the plant (Capacity), the product water amount per train (Capacity/Train), the temperature (Temperature), the layout of membrane combination (Layout) are displayed, and operational data 804, 805, and scaling data 806 is displayed.

At this instance, when the “List” button 810 is pressed, the calculation result list display screen 700 shown in FIG. 11 is displayed again.

As described above, using the calculation result list display screen 700 in FIG. 12, the user can obtain the operational performance data and water quality data upon running as list data for each of cases of all combination of input data set in the input condition setting unit 110. In addition, the user can easily know a case in which a desired operational performance data and water quality data can be provided

The user can obtain the operational performances of the reverse osmosis equipment determined by input condition data of various cases upon development and designing of the reverse osmosis equipment all together according to the embodiments described above. Accordingly, because the user can easily compare layouts of the membrane combination structure in the reverse osmosis equipment in accordance with the raw water condition and the product water condition.

The present invention is not limited to the embodiments described above, and there are various modifications. For example, the embodiment described above is described in details to be easily understood, but not limited to an embodiment including all the structures described above. Further, a part of a structure in one embodiment can be replaced with a part of another embodiment. It may be possible to add a part or all of the structure of the other embodiment to a part of a structure in one embodiment.

### DESCRIPTION OF REFERENCE SYMBOLS

10 reverse osmosis equipment performance calculation device
100 operation process device
110 input condition setting unit
111 raw water condition setting unit
112 raw water detail setting unit
113 operational condition setting unit
114 product water condition setting unit
120 calculating condition list generating unit
130 operational performance calculating unit
140 operational performance calculating result display unit
141 calculation result list display unit
142 calculation result detail display screen
200 storage
210 input condition storing unit
211 raw water condition storing unit
212 operational condition storing unit
213 product water condition storing unit
220 calculating condition list storing unit
230 membrane type and structural layout storing unit
240 operational performance calculation result storing unit
300 input device
301 input condition setting screen
302 raw water detailed setting screen
310 raw water condition setting window (first sub-screen)
320 temperature setting unit
330 TDS setting unit
339 WQD button
340 operational condition setting window (second sub-screen)
341 layout selection entry field
360 operational condition data setting frame
361 recovery rate setting unit
362 flux setting unit
370 product water condition setting window (third sub-screen)
371 product water amount setting unit
380 the-number-of-case display window
400 display device
420 calculating condition list data
431 membrane type database
440 operational performance calculation result data
700 calculation result list display screen
800 calculation result detail display screen

1. A reverse osmosis equipment performance calculation method comprising:
a first step displaying on a display device an input condition setting screen setting an input condition necessary for an operational performance calculation of a reverse osmosis equipment;
a second step generating calculation conditions of a plurality of cases used in the operational performance calculation as a calculation condition list on the basis of the input condition set through the input condition setting screen;
a third step successively reading out one of the cases of calculation conditions from the generated calculation condition list and executing the operational performance calculation corresponding to the read out calculation condition, which are repeated for a plurality of the cases; and
a fourth step displaying a calculation result list of the plurality of the cases obtained by the operational performance calculation in the third step on the display device, the first to fourth steps are executed with a computer.

2. The reverse osmosis equipment performance calculation method as claimed in claim 1, wherein displayed on the input condition setting screen displayed in the first step are:
a first sub-screen setting a condition of a raw water supplied to the reverse osmosis equipment;
a second sub-screen setting a layout and an operational condition of a combination structure of reverse osmosis membranes used in the reverse osmosis equipment; and
a third sub-screen setting a condition of product water produced through the reverse osmosis equipment.

3. The reverse osmosis equipment performance calculation method as claimed in claim 1, wherein
on a display screen in which a list of the calculation results of the plurality of cases is displayed in the fourth step, a fourth sub-screen setting a narrowing condition for narrowing a part of the cases of which the calculation results are desirable is further displayed.

4. The reverse osmosis equipment performance calculation method as claimed in claim 3, wherein when the narrowing condition is set through the fourth sub-screen, the method further comprising:
determining whether the calculation result of each of the cases displayed on the list display screen of the calculation result meets the narrowing condition, and when the calculation result meets the narrowing condition, the calculation result of the case is displayed and highlighted.

5. A reverse osmosis equipment performance calculation device, comprising:
an input condition setting unit displaying on a display device an input condition setting screen for setting an input condition necessary for an operational performance calculation of a reverse osmosis equipment;
a calculation condition list generating unit generating calculation conditions of a plurality of cases used in the operational performance calculation as a calculation condition list on the basis of the input condition set through the input condition setting screen;
an operational performance calculating unit successively reading out one of the cases of calculation conditions from the generated calculation condition list and executing the operational performance calculation corresponding to the read out calculation condition, which are repeated for a plurality of the cases; and
a calculation result displaying unit displaying a calculation result list of the plurality of the cases obtained by the operational performance calculation by the operational performance calculating unit.

6. The reverse osmosis equipment performance calculation device as claimed in claim 5, wherein displayed on the input condition setting screen displayed by the input condition setting unit are:
a first sub-screen setting a condition of a raw water supplied to the reverse osmosis equipment;
a second sub-screen setting a layout and an operational condition of a combination structure of reverse osmosis membranes used in the reverse osmosis equipment; and
a third sub-screen setting a condition of product water produced through the reverse osmosis equipment.

7. The reverse osmosis equipment performance calculation device as claimed in claim 5, wherein
on a display screen in which a list of the calculation results of the plurality of cases is displayed by the calculation result displaying unit, a fourth sub-screen setting a narrowing condition for narrowing a part of the cases of which the calculation results are desirable is further displayed.

8. The reverse osmosis equipment performance calculation device as claimed in claim 7, wherein
when the narrowing condition is set through the fourth sub-screen, the reverse osmosis equipment performance calculation device further comprising:
determining whether the calculation result of each of the cases displayed on the list display screen of the calculation result meets the narrowing condition, and when the calculation result meets the narrowing condition, the calculation result of the case is displayed and highlighted.

9. A program executing the reverse osmosis equipment performance calculation method as claimed in claim 1.

10. A program executing the reverse osmosis equipment performance calculation method as claimed in claim 2.

11. A program executing the reverse osmosis equipment performance calculation method as claimed in claim 3.

12. A program executing the reverse osmosis equipment performance calculation method as claimed in claim 4.
